(19) United States
(12) Patent Application Publication
(10) Pub. No.: US 2006/0198637 A1
(43) Pub. Date: Sep. 7, 2006

(54) Non-directional infrared remote-control transmitter for infrared remote control system

(76) Inventor: George Lin, Yung Kang City (TW)

Correspondence Address: PRO-TECTOR INTERNATIONAL SERVICES, 20775 NORADA CT., SARATOGA, CA, 95070, US

(21) Appl. No.: 11/071,040

(22) Filed: Mar. 2, 2005

(51) Int. Cl. H04B 10/00

(52) U.S. Cl. 398/106

(57) ABSTRACT

A non-directional infrared remote-control transmitter for infrared remote control system is disclosed to include a remote-control function setting module for setting remote-control control status, a controller for receiving signal from the remote-control function setting module, and a driver circuit, which has multiple infrared transmitting devices disposed at different directions and controllable by the controller to transmit an infrared signal subject to signal from the remote-control function setting module.

### BACKGROUND OF THE INVENTION

1. Field of the Invention

The present invention relates to an infrared remote control system and more particularly, to a non-directional infrared remote-control transmitter.

2. Description of the Related Art

Many infrared remote-control transmitters have been disclosed and are intensively used in modern electric/electronic home appliances for controlling different operation status of the electric/electronic home appliances, for example, on/off status and temperature regulation of a cooler.

Conventional infrared remote-control transmitters commonly use an infrared transmitting device to emit infrared signal. When in use, the user must aim the infrared transmitting device of the infrared remote controller at the infrared receiver at the load. If the infrared transmitting device of the infrared remote controller is not aimed at the infrared receiver at the load, the infrared receiver will receive no signal from the infrared remote controller. This drawback makes the use of the controller inconvenient.

### SUMMARY OF THE INVENTION

The present invention has been accomplished under the circumstances in view.

It is the main object of the present invention to provide a non-directional infrared remote-control transmitter, which uses multiple infrared transmitting devices to transmit an infrared signal containing a data signal in different directions so that the transmitter can conveniently operated to control the controlled device without aiming at the infrared receiver at the controlled device.

According to one aspect of the present invention, the non-directional infrared remote-control transmitter comprises a remote-control function setting module, a sensor unit, a controller, and a driver circuit. The remote-control function setting module is installed in a transmitter control board for setting the control of the status of a controlled device. The sensor unit is installed in the same transmitter board for detecting surrounding status. The controller is adapted to receive and process signals from the remote-control function setting module and the sensor unit. The driver circuit comprises a set of infrared transmitting devices controllable by the controller to transmit infrared signal into the air.

According to another aspect of the present invention, infrared transmitting devices of the driver circuit are respectively mounted on the front, left, right, top and bottom sides of the housing of the transmitter so that the driver circuit can be controlled to drive the infrared transmitting devices to transmit infrared signal into the air in all directions, achieving non-directional infrared control.

According to still another aspect of the present invention, a display device is electrically connected to the controller for indication of the operation status of the non-directional infrared remote-control transmitter.

### BRIEF DESCRIPTION OF THE DRAWINGS

FIG. 1 is a circuit diagram of a non-directional infrared remote-control transmitter according to the present invention.

FIG. 2 is a system block diagram of the non-directional infrared remote-control transmitter according to the present invention.

### DETAILED DESCRIPTION OF THE PREFERRED EMBODIMENT

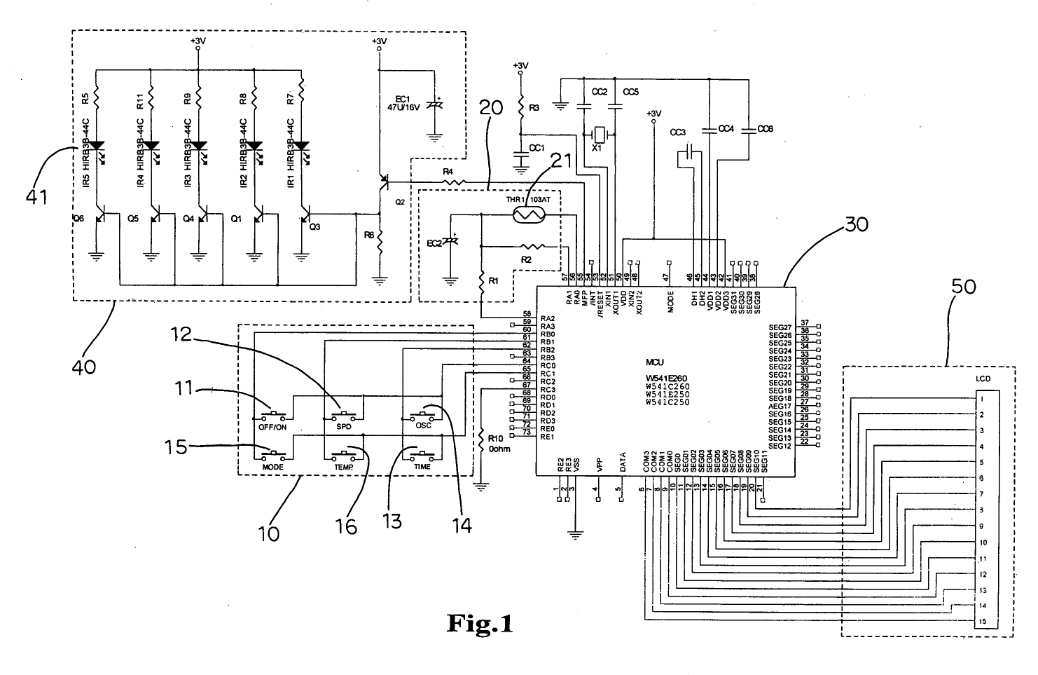

FIG. 1 is a circuit diagram of a non-directional infrared remote-control transmitter according to the present invention. This circuit diagram is simply an exemplar embodiment of the present invention but not a limitation. According to this embodiment, the non-directional infrared remote-control transmitter is used for controlling the operation of an auto temperature-control fan.

As illustrated, the non-directional infrared remote-control transmitter comprises a remote-control function setting module 10, a sensor unit 20, a controller 30, a driver circuit 40, and a display device 50.

The remote-control function setting module 10 is installed in a transmitter control board for setting the control of the status of a controlled device, comprising a plurality of function keys including OFF/ON button 11 for fan on/off control, a SPD button 12 for fan speed selection control, TIME button 13 for time setting control, OSC button 14 for fan oscillation control, MODE button 15 for operation mode selection control, and TEMP button 16 for temperature setting/change control.

The sensor unit 20 is installed in the same transmitter board, comprising at least one sensor 21 for detecting ad adapted to detect the temperature of the surroundings. The sensor 21 can be a thermistor or temperature sensor. Alternatively, the sensor 21 can be a gas sensor adapted to detect a particular gas.

The controller 30 is adapted to receive and process signals from the remote-control function setting module 10 and the sensor unit 20.

The driver circuit 40 comprises a set of infrared transmitting devices 41 including IR1, IR2, IR3, IR4, IR5 controllable by the controller 30 to transmit infrared signal into the air.

The display device 50 is electrically connected to the controller 30 and adapted to display the status of the infrared remote-control transmitter, for example, fan speed status, time setting status of the TIME button 13, setting status of operation mode, temperature setting status, and etc.

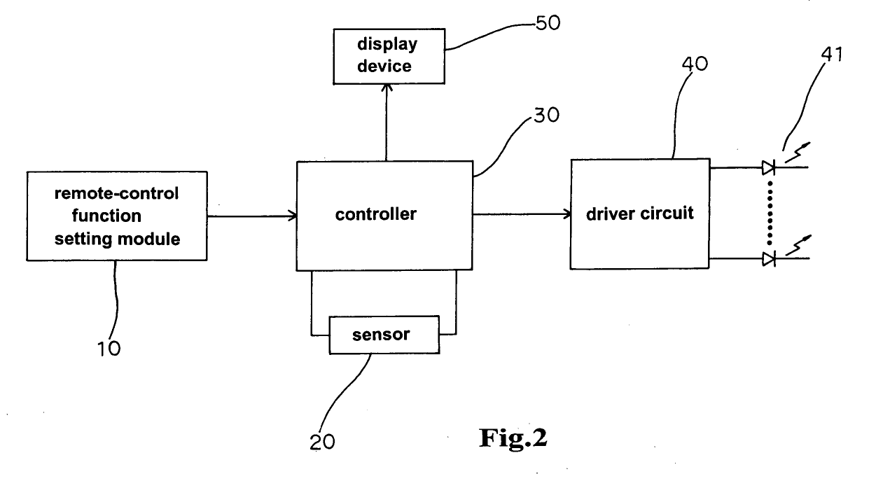

Referring to FIG. 2, after start of the a remote-control function setting module 10, the sensor unit 20 provides detected data to the controller 30, which compares the received with preset reference data and then provides a voltage to the driver circuit 40 subject to the comparison result, causing the infrared transmitting devices 41 to transmit a corresponding infrared signal into the air.

As stated above, set of infrared transmitting devices 41 includes IR1, IR2, IR3, IR4, IR5. These infrared transmitting devices IR1, IR2, IR3, IR4, IR5 are respectively mounted on the front, left, right, top and bottom sides of the housing of the directional infrared remote-control transmitter, so that the infrared signal is transmitted into the air in all directions, achieving the desired non-directional remote control function. The transmitted infrared signal contains data signal provided for the infrared receiving side of the controlled device.

Therefore, the user can use one single infrared remote-control transmitter to achieve non-directional infrared remote-control function for data transmission, i.e., the invention greatly improves the convenience of the use of an infrared remote-control transmitter.

Although a particular embodiment of the invention had been described in detail for purposes of illustration, various modifications and enhancements may be made without departing from the spirit and scope of the invention.

What the invention claimed is:

1. A non-directional infrared remote-control transmitter comprising:
a remote-control function setting module for setting remote-control control status;
a controller adapted to receive signal from said remote-control function setting module; and
a driver circuit, said driver circuit comprising a plurality of infrared transmitting devices controllable by said controller to transmit an infrared signal subject to signal from said remote-control function setting module.

2. The non-directional infrared remote-control transmitter as claimed in claim 1, further comprising sensor means electrically connected to said controller and adapted to detect surrounding status and to provide detected data to said controller.

3. The non-directional infrared remote-control transmitter as claimed in claim 1, further comprising a display device electrically connected to said controller for indication of the operation status of the non-directional infrared remote-control transmitter.

4. The non-directional infrared remote-control transmitter as claimed in claim 1, wherein said infrared transmitter devices are respectively mounted on front, left, right, top and bottom side of a housing of the non-directional infrared remote-control transmitter that holds said remote-control function setting module, said controller and said driver circuit on the inside.

5. The non-directional infrared remote-control transmitter as claimed in claim 1, wherein said remote-control function setting module comprises a plurality of function keys for controlling the operating status of a controlled device.

6. The non-directional infrared remote-control transmitter as claimed in claim 2, wherein said sensor means comprises a thermistor.

7. The non-directional infrared remote-control transmitter as claimed in claim 2, wherein said sensor means comprises at least one temperature sensor.

8. The non-directional infrared remote-control transmitter as claimed in claim 2, wherein said sensor means comprises at least one gas sensor.
